(19) United States
(12) Patent Application Publication
(10) Pub. No.: US 2008/0225812 A1
(43) Pub. Date: Sep. 18, 2008

(54) VoIP-only Base Transceiver Station

(76) Inventors: David Burgess, Fairfield, CA (US); Harvind Samra, Fairfield, CA (US); Roshan Baliga, Mountain View, CA (US)

Correspondence Address: David Burgess, 2253 Fox Glen Dr., Fairfield, CA, 94534, US

(21) Appl. No.: 12/047,304

(22) Filed: Mar. 12, 2008

Related U.S. Application Data
(60) Provisional application No. 60/906,532, filed on Mar. 13, 2007.

(51) Int. Cl. H04Q 7/24; H04L 12/66

(52) U.S. Cl. 370/338; 370/352

(57) ABSTRACT

Embodiments for a low-cost, flexible, VoIP-Only Base Transceiver Station are disclosed.

### FIELD OF THE INVENTION

The present invention relates in general to the mobile communications field, in particular, to a method and system for reducing the cost and increasing the flexibility of a base transceiver station (BTS) in a cellular network.

### CROSS REFERENCE TO DISCLOSURE DOCUMENT

This application is based upon provisional utility patent application #60906532 filed 13 Mar. 2007.

### BACKGROUND OF THE INVENTION

Conventional cellular systems inherit their infrastructure and engineering approach from the switched circuit telephone world. The result is a base transceiver station (BTS) packed with hardware but with little intelligence of its own. Such a BTS is dependent on a complex network of leased lines and switching centers to perform any useful function. Most of the cellular infrastructure is unnecessary as it is already possible to run a high-performance cellular receiver on a modestly-priced general-purpose CPU. Combining a low-cost all-software BTS design with “Voice over Internet Protocol” (VoIP) backhaul would allow a network operator to offer cellular coverage at a much lower cost than conventional systems.

A VoIP-only BTS, using a software-defined radio, would be capable of performing many of the functions that are performed today at mobile switching centers (MSCs). This would allow the BTS to operate semi-autonomously, making decisions about handovers and channel capacity without intervention from a MSC. The use of VoIP would reduce the cost of operation and maintenance by leveraging existing wireless network equipment and operational knowledge.

Existing inventions describe the use of VoIP in a cellular phone network. However, these inventions do not include the use of VoIP for the entire backhaul, as typical BTSs are incapable of making required decisions about channel use, call handover, and call routing.

U.S. patent application Ser. No. 11/154,775—Bonner et al (2005)

This patent application describes a system used to connect a mobile station to two networks; a cellular network, and a IP network used for VoIP. This invention grants more flexibility by allowing a MS to receive phone calls over a WiFi (802.11) network in areas with little or no GSM coverage. The present invention differs in that VoIP/IP will be used among BTSs and from BTS to Public Switched Telephone Network (PSTN) Gateways, not from the MS to the BTS.

U.S. Pat. No. 6,594,253—Sallberg et al (2003)

This patent describes a system for connecting a VoIP call to an idle MS. In the embodiment specified, the VoIP call is transformed to a normal cellular call at the MSC, and then passed through the BTS to the MS. This differs from the present invention in two ways. First, the present invention uses VoIP directly to the BTS, rather than terminating at the MSC. This requires a more intelligent BTS, as specified herein. Second, the present invention uses VoIP as its only call transfer protocol, rather than using a hybrid VoIP/GSM, which would increase expense.

Existing inventions also describe the use of a software-defined radio in various wireless base stations. However, these inventions focus on the use of a software-defined radio to enable a base station to service multiple RF standards.

U.S. patent application Ser. No. 11/078,808—Pottenger et al (2005)

This patent application includes a claim for a software-defined radio modem, which allows for re-configurability. The present invention goes above and beyond Pottenger's claim, by using a software-defined radio to allow rapid, dynamic, automated channel allocation and call handovers at the BTS.

U.S. Pat. No. 6,584,146—Bose, et al (2003)

This patent also focuses on re-configurability of the base station to support multiple wireless communication protocols. It also includes a claim for dynamic redistribution of processing capability to support different protocols, but does not include a claim for dynamic, automated channel allocation and call handovers.

### BRIEF SUMMARY OF THE INVENTION

The VoIP-only BTS is a cellular base transceiver station designed to achieve low operating costs and increased flexibility through these features:
1. Use of a software radio approach that allows the higher functions (L3 and control layer) of the BTS to have close communication with the physical layer functions of the radio.
2. Movement of the telephone call switching functions into the BTS, allowing it to use VoIP for call placement, bypassing nearly all of the conventional cellular infrastructure, cutting backhaul requirements, and replacing specialized leased-line (SS7, etc.) equipment with commodity ethernet and wireless LAN networking components.
3. Adaptive automation of the radio configuration, making the cellular network maintainable by ordinary information technology workers, not cellular specialists.

### BRIEF DESCRIPTION OF THE DRAWINGS

FIG. 1 shows a complete multi-cell VoIP-only BTS network. Links are labeled as to the protocols used in the preferred embodiment. The subscriber registry and BTS registries are databases used for call routing and handovers. In the preferred embodiment, records from these databases are cached locally in each BTS to minimize reliance on the IP network. In a network with only one BTS, these databases can be co-located with the BTS hardware. The VoIP gateway component is optional and can be replaced with services purchased from a commercial VoIP telephone carrier.

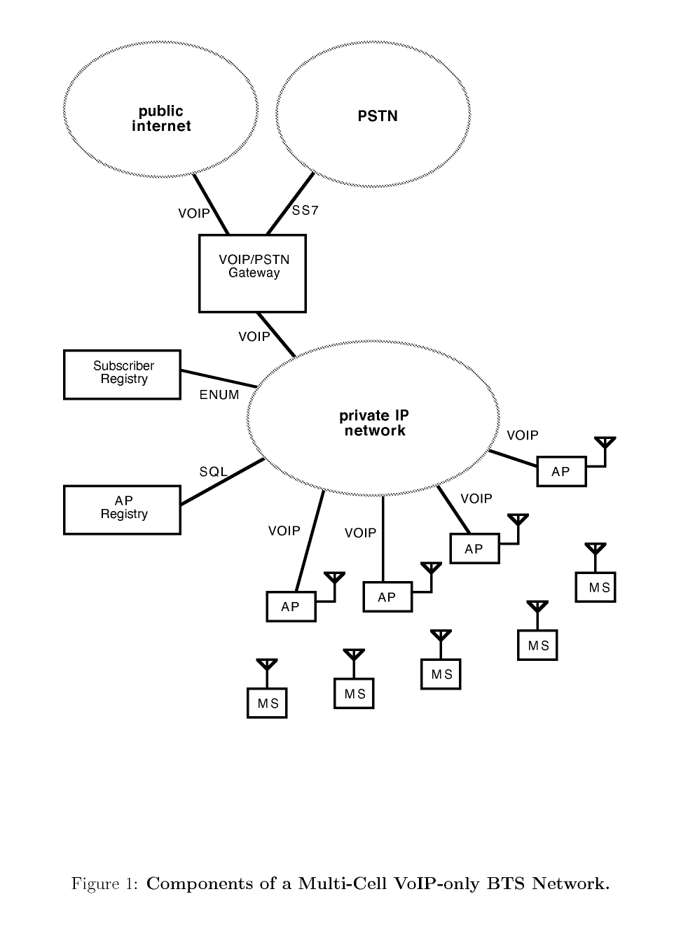

FIG. 2 shows the components of a VoIP-only BTS. The dashed line encompasses the software components of the BTS, which in the preferred embodiment run on an embedded linux computer. Unlike a typical BTS, the invention includes a local control layer. The GSM Layer 1, 2, and 3 functions all run in software at the BTS, and are tightly coupled with the control layers and configuration components. This allows the BTS to make intelligent decisions about channel usage and call handovers. All required voice transcoding is performed in software at the BTS, allowing a straightforward VoIP connection from the BTS to/from the private IP network (as shown in FIG. 1).

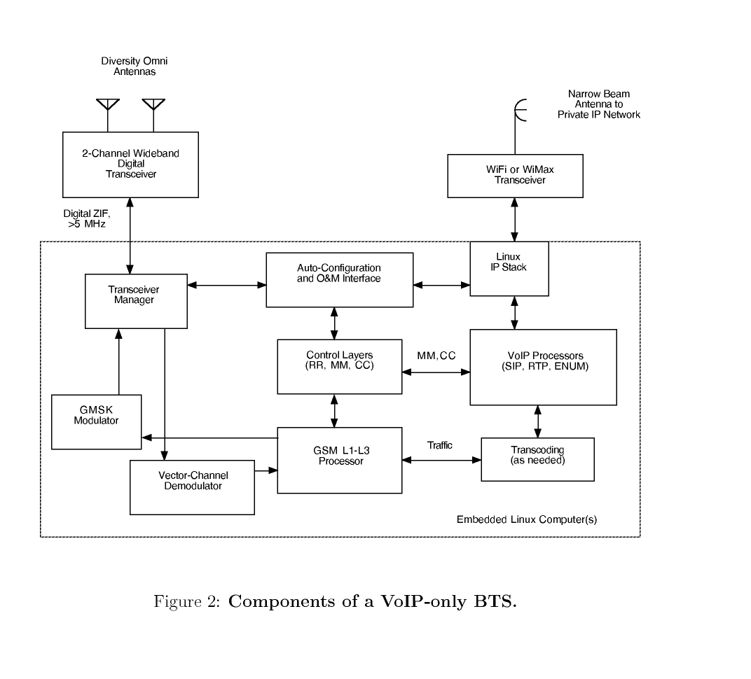

### DETAILED DESCRIPTION OF EXAMPLE EMBODIMENTS

### Operations and Maintenance Functions

The invention will simplify O&M procedures by automating the configuration of radio resource functions. The invention will automate its configuration of channel combinations to match the pattern of requested service in its operating area. The invention will use measurement reports from subscriber MSs and radio channel scanning from a GSM test receiver to automatically choose an Absolute Radio Frequency Channel Number (ARFCN) set and to automatically set power levels. The status of each BTS will be reported to remote monitoring stations through an open protocol. In the preferred embodiment the BTS status is reported via the Simple Network Management Protocol (SNMP) and monitored with readily available open-source software.

To facilitate handovers, user location and automatic configuration the BTS network will include a database of installed BTS units including their various networking addresses and geographic locations. This database can be in a central server or distributed across the BTS processors themselves. Most information in this database will be collected automatically, although the O&M staff may need to enter certain information when a new BTS is installed.

To facilitate call routing and billing the BTS network will include a database of subscribers. This database can be in a central server or distributed across the BTS processors themselves. In the preferred embodiment this would be a central database with cached records in the individual BTS processors. Most information in this database will be collected automatically, although the O&M staff will need to enter identity and addressing information for new subscribers and update records to reflect subscriber payments and changes to subscriber services, addresses, etc.

In the preferred embodiment all databases use a common standard interface such as Simple Query Language (SQL) and be implemented with readily available open-source software.

### Modified GSM Stack

Unlike a conventional BTS, the invention includes a local control layer to establish radio channels, connect calls and transfer short message data without intervention from a basestation controller (BSC) or mobile switching center (MSC).

The various L3 protocols within the VoIP-only BTS are terminated and interfaced in the control layer as follows:
Radio Resource. This protocol is used to manage radio channels between the BTS and MS. Normally, this protocol is terminated in the MSC and BSC with no decision functions in the BTS. In the VoIP-only BTS, radio resources are managed by the BTS itself and all messages in this protocol are terminated locally.
Mobility Management. This protocol is used to track subscribers as they move through the network so that calls can be routed appropriately. Normally, this protocol is terminated in the MSC and location registers with no decision functions in the BTS or BSC. In the invention, messages in this protocol are terminated in the BTS. External database requests are processed for uncached subscriber records using a combination of standard protocols.
Call Control. This is the protocol for connecting circuit-switched calls. Normally, this protocol is terminated in the MSC. For voice calls, the invention presents this protocol in a software interface that is functionally equivalent to a private branch exchange (PBX). VoIP protocols connect on this PBX interface. For data connections, the invention provides an internal PPP server and router.
SMS. This is the protocol for text messages. Normally, this protocol terminates L3 in the MSC and terminates higher layers in the Short Message Service Center (SMSC). In the VoIP-only BTS model this protocol terminates L3 in the BTS with higher layers translated to a standard IP-based messaging protocol. In the preferred embodiment the IP messaging protocol is SMTP, SMPP or SIMPLE.

### Switching at the BTS

Because the invention terminates L3 transactions locally it is capable of connecting in-network calls without hairpinning into a larger network. In a network of VoIP-only BTSs, call connection topology is strictly hierarchical, with any established call path going no farther than the nearest common IP switching point. For example, if two subscribers connect a call through the same BTS, that call can be connected within that BTS with the backhaul used only to check external databases and then only when cached records are not available locally. For in-network calls, VoIP-only BTSs can connect to each other using the closest common IP router or switch.

### Dynamic Capacity

The invention has the ability to change the configuration of any idle channel without disrupting in-progess calls and transactions. The invention will automatically convert channels between full-rate and half-rate so as to maximize voice quality during low-demand periods and maximize capacity during high-demand periods. As traffic demand grows some users may get lower-quality half-rate connections but more calls will continue to go through without blocking. This behavior affords the BTS a surge capacity of at least twice its normal capacity without operator intervention.

The invention has the ability to autonomously convert between voice traffic channels and control channels as needed to match the mix of voice calls, location updates and text message traffic at any given time.

### VoIP Protocols

For in-network calls the preferred embodiment of the invention will use a VoIP protocol based on a combination of Session Initiation Protocol (SIP), Real Time Protocol (RTP) and whichever vocoders may be in common to the called and calling parties. The invention will connect in-network calls by direct transfer of user traffic frames without transcoding.

For out-of-network calls the preferred embodiment of the invention will use an open-standard VoIP protocol suitable to the application. Multiple protocols may be supported. For VoIP calls the invention will attempt to use vocoders supported in common by the subscriber and VoIP carrier. When such common vocoders are available, the invention will transfer user traffic frames directly without transcoding.

For any call type, when multiple vocoders are available, the vocoder for a call can be chosen on the basis of available radio channel and backhaul bandwidth so as to automatically maximize voice quality in low-demand periods and maximize capacity in high-demand periods.

In the preferred embodiment all in-network call connections are performed with readily-available open source VoIP software.

### Backhaul

In some embodiments, the invention may use its existing receiver features as part of a modem to transfer data in the cellular band for the purpose of communication with other wireless telephone basestations or for connection to a public or private IP network.

In other embodiments the invention may use wireless networking interfaces from the 802.11 or 802.16 families for the purpose of communication with other wireless telephone basestations or for connection to a public or private IP network.

### Other Embodiments

In the foregoing specification, the invention has been described with reference to specific exemplary embodiments thereof. It will, however, be evident that various modifications and changes may be made thereunto without departing from the broader spirit and scope of the invention as set forth in the appended claims. The specifications and drawings are, accordingly, to be regarded in an illustrative rather than in a restrictive sense.

What is claimed is:

1. A wireless base transceiver station (BTS) of a mobile wireless system, for communication with one or more mobile stations, wherein voice calls are transmitted to/from other BTSs and PSTN gateways via VoIP over a private IP network.

2. A wireless base transceiver station as defined in claim 1, wherein the BTS automatically selects the appropriate VoIP vocoder based on bandwidth available in the private IP network.

3. A wireless base transceiver station as defined in claim 1, wherein the BTS automatically selects the appropriate VoIP vocoder based on the capabilities of the VoIP Gateway.

4. A wireless base transceiver station as defined in claim 1, wherein the BTS includes a GSM test receiver to monitor the availability of channels in the vicinity.

5. A wireless base transceiver station as defined in claim 1, wherein the BTS converts text messages directly into IP packets for transmission over the private IP network using one of the following protocols: SMTP, SMPP, SIMPLE, XMPP.

6. A wireless base transceiver station as defined in claim 1, wherein the BTS itself controls call switching using a distributed or cached database, directly connects calls between itself and other BTSs, and locally terminates circuit-switched calls.

7. A wireless base transceiver station as defined in claim 1, wherein the BTS employs a software-defined radio, including GSM layers 1, 2, and 3, and the following control layers: Radio Resource Management, Mobility Management, and Connection Management.

8. A wireless base transceiver station as defined in claim 7, wherein the BTS dynamically and autonomously converts idle channels between full-rate and half-rate, to balance capacity and connection quality.

9. A wireless base transceiver station as defined in claim 7, wherein the BTS dynamically and autonomously converts among control channels, voice channels, and text message traffic, to balance capacity and connection quality.

10. A wireless base transceiver station as defined in claim 7, wherein the BTS performs MS handovers to other BTSs without interventions from a base station controller or mobile switching center.

11. A wireless base transceiver station as defined in claim 7, wherein the BTS dynamically and autonomously chooses specific ARFCNs and power levels without intervention from a base station controller or mobile switching center.

12. A wireless base transceiver station as defined in claim 7, wherein the BTS dynamically and autonomously chooses early or late call assignment based on current resource availability, and history of the subscriber behavior.
